(19) United States
(12) Patent Application Publication
(10) Pub. No.: US 2026/0089552 A1
(43) Pub. Date: Mar. 26, 2026

(54) RAN AWARE PROACTIVE MULTI-PACKET LINK ADAPTATION

(71) Applicant: APPLE INC., Cupertino, CA (US)

(72) Inventors: Onur Sahin, San Diego, CA (US); Arnab Roy, San Diego, CA (US); Oner Orhan, San Jose, CA (US); Norman Goris, Dortmund (DE); Ahmed M. Soliman, Munich (DE); Ayman F. Naguib, Cupertino, CA (US); Ping-Heng Kuo, London (GB); Ralf Rossbach, Munich (DE)

(21) Appl. No.: 19/314,487

(22) Filed: Aug. 29, 2025

Related U.S. Application Data
(60) Provisional application No. 63/699,594, filed on Sep. 26, 2024.

(51) Int. Cl. H04W 28/02; H04L 1/1812; H04W 28/06

(52) U.S. Cl. CPC H04W 28/0278; H04L 1/1812; H04W 28/06

(57) ABSTRACT

Embodiments herein include a UE that receives one or more packets of a downlink packet set from a network node. The UE may identify a remaining delay budget and a remaining packet error budget for remaining packets of the downlink packet set based on Key Performance Indicator (KPI) requirements. The UE may perform a packet error prediction for the remaining packets, and perform a link adaptation operation based on the prediction and the remaining delay budget. A network node may perform similar actions on an uplink packet set.

### TECHNICAL FIELD

This application relates generally to wireless communication systems, including adaptively changing a transmit configuration for a packet set.

### BACKGROUND

Wireless mobile communication technology uses various standards and protocols to transmit data between a base station and a wireless communication device. Wireless communication system standards and protocols can include, for example, 3rd Generation Partnership Project (3GPP) Long Term Evolution (LTE) (e.g., 4G), 3GPP New Radio (NR) (e.g., 5G), and Institute of Electrical and Electronics Engineers (IEEE) 802.11 standard for Wireless Local Area Networks (WLAN) (commonly known to industry groups as Wi-Fi®).

As contemplated by the 3GPP, different wireless communication systems' standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, Global System for Mobile communications (GSM), Enhanced Data Rates for GSM Evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements Universal Mobile Telecommunication System (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC) while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example of a PDU sent using retransmission, a PDU sent using repetition coding, and a PDU sent using linear packet coding in accordance with some embodiments.

FIG. 2 illustrates an example signal flow diagram of proactive multi-packet link adaptation in the uplink using application layer coding in accordance with some embodiments.

FIG. 3 illustrates specific UE-side procedures for the proactive multi-packet link adaptation in the uplink using application layer coding in accordance with some embodiments.

FIG. 4 illustrates specific network-side procedures for the proactive multi-packet link adaptation in the uplink using application layer coding in accordance with some embodiments.

FIG. 5 illustrates a flow chart of an example method for network-side procedures for the proactive multi-packet link adaptation in the uplink in accordance with some embodiments.

FIG. 6 illustrates an example signal flow diagram of proactive multi-packet link adaptation in the downlink using application layer coding in accordance with some embodiments.

FIG. 7 illustrates specific network-side procedures for the proactive multi-packet link adaptation in the downlink using application layer coding in accordance with some embodiments.

FIG. 8 illustrates specific UE-side procedures for the proactive multi-packet link adaptation in the downlink using application layer coding in accordance with some embodiments.

FIG. 9 illustrates a method performed by a UE, according to embodiments herein.

FIG. 10 illustrates a method performed by a network node, according to embodiments herein.

FIG. 11 illustrates a method performed by a UE, according to embodiments herein.

FIG. 12 illustrates an example architecture of a wireless communication system, according to embodiments disclosed herein.

FIG. 13 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

In wireless communication systems, such as those defined by 3GPP, the transmission of data over unreliable channels poses significant challenges due to factors like interference, fading, and noise. To ensure reliable data delivery, wireless communication systems can incorporate re-transmission framework mechanisms that may include redundancy mechanisms and linear packet coding techniques. These components can play a role in maintaining data integrity and optimizing network performance.

Redundancy mechanisms, including retransmission framework, may be used in various layers in wireless systems including: 1—Physical Layer/Medium Access Control Layer Hybrid Automatic Repeat Request (PHY/MAC HARQ), 2—Radio Link Control (RLC) Acknowledged Mode (AM) ARQ, 3—Packet Data Convergence Protocol (PDCP) packet discarding/duplication, 4—Application layer Forward Error Correction (AL-FEC).

Linear packet coding may include network coding, fountain codes, etc. Linear packet coding may be used as additional redundancy mechanisms on top of advanced ARQ schemes with complex coding techniques (e.g., Low-Density Parity-Check (LDPC), Polar, etc.) that are generally used in MAC/PHY layers. One advantage of linear packet coding is lower complexity compared with bit-processing based coding schemes as in LDPC or Polar codes. Moreover, linear packet coding can benefit from lower end-to-end latency since this scheme does not necessarily require retransmission feedback as opposed to some other HARQ based techniques. Hence, linear packet coding may provide potential benefit of reduced end-to-end latency for a given set of packets that are coded jointly.

Using linear packet coding may be applied in various layers in the protocol stack, including Application layer, PDCP, and RLC for unicast and multicast deployments. For instance, in the application layer, linear packet decoding for multi-cast scenarios may be used due to lack of or limited feedback/retransmission schemes from the receivers to the transmitter. For uni-cast scenarios, linear packet decoding may be used for real-time video transmission where the delay budget requirement of the video transmission is expected to be lower than end-to-end packet latency. For uni-cast scenarios linear packet decoding may be used to reduce the end-to-end latency of Protocol Data Unit (PDU) transmission, hence potentially avoiding PDU set discard due to exceeding PDU delay budget.

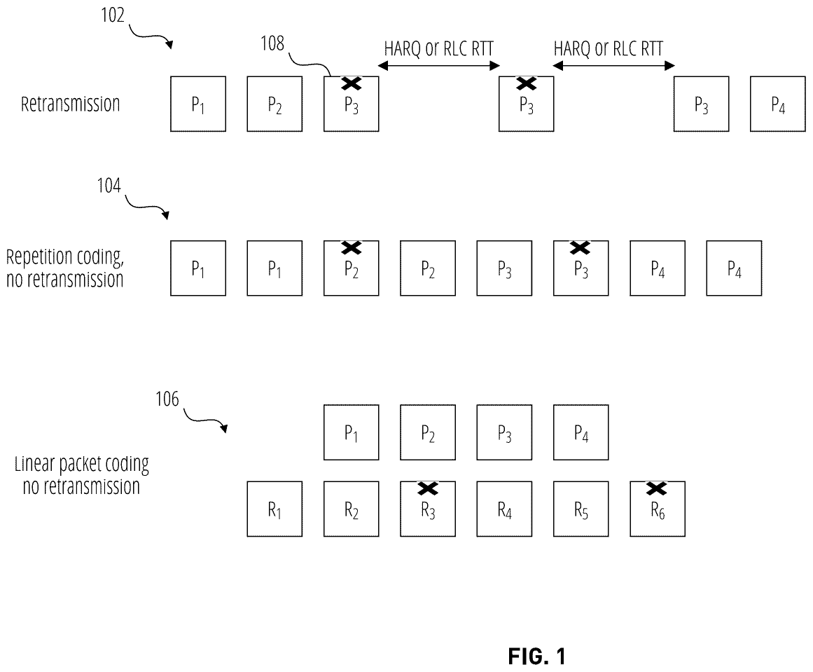

FIG. 1 illustrates an example of a PDU 102 sent using retransmission, a PDU 104 sent using repetition coding, and a PDU 106 sent using linear packet coding in accordance with some embodiments. Using linear packet coding versus retransmission may result in throughput, latency, and packet error rate (PER) trade-offs.

For example, the PDU 102 sent using retransmission may be considered reactive redundancy. As shown, if a system does not use linear packet coding, and if a packet is in error (e.g., packet 108), the system triggers HARQ or retransmits the packet. This may result in increased latency due to retransmission (ACK/NACK round-tip time (RTT)), RLC, MAC/PHY.

The PDU 104 sent using repetition coding may be considered proactive redundancy. Instead of waiting for a packet error, the packets may be sent with packet repetition (e.g., two of every packet in the PDU 104). Because there is packet repetition, there may not be a retransmission even if there is a packet error. Knowledge about error statistics may be used when implementing packet repetition.

The PDU 106 sent using linear packet coding may also be considered proactive redundancy. The system may use network coding, and there may be no retransmission even if there is packet error because of the linear packet coding. Error statistics information may be useful, but a lot less stringent than with repetition coding. Also, linear packet coding may be more efficient than repetition coding in terms of bandwidth utilization. Further, linear packet coding may result in a lower latency than retransmission.

A first issue with some systems is that existing linear coding mechanisms are reactive and the mechanisms may include a non-adaptive transmit configuration of multi-packet applications under a given Key Performance Indicator (KPI) constraint set. There are various applications that include multiple packets, such as protocol data unit (PDU set) or application data unit (ADU), with a given total delay budget and tolerance to error across these packets. For instance, for PDU sets in Extended Reality (XR), the whole packet set is considered in error (and discarded) if one or a given number of packets are in error (e.g., PDU Set error rate (PSER)>Pthreshold, error) among the whole set. Similarly, in XR, the whole PDU set has to be received within the delay budget (e.g., PDU set delay budget (PSDB)>Pthreshold, delay). In application layer, some applications are constrained by delay budgets and packet error thresholds, which necessitate all ADUs to be received within these quality of service (QoS) KPIs.

In some embodiments, possible transmit configurations of these packets may be based on the performance requirements of the application and/or PDU set such as packet error rate, delay budget, throughput, etc. This may include linear packet coding that is applicable at the application layer and/or PDCP and/or RLC, and radio access transmission configurations (e.g., link adaptation set-up (including logical channel selection, PDCP duplication, RLC re-transmission mode, MAC configuration, etc.)).

In some embodiments, treatment of these packets are reactive by the network. For example, multiple application layer packets, and/or PDU set may go through a pre-determined QoS handling/transmit configuration prior to the actual transmission of these packets. Based on the errors and/or, the network may react according to the configuration.

However, each packet (or PDU) might experience varying transmission conditions due to wireless channel, air-interface congestion, etc., which could be detrimental for the overall packet set KPI requirements. For instance, one packet might experience relatively high delay, hence reducing delay budget allowance for other packets in the set, etc. As another example, a number of packets might experience failure, which may put the remaining packets in highly stringent error requirements.

Moreover, a reactive configuration of transmit parameters might further result in unnecessary radio resource utilization. For instance, some systems (e.g., network node and/or UE) are not able to pro-actively predict and identify that upcoming packets in a set may not be transmitted within the remaining KPI constraints. Therefore, some packets in the set might be transmitted unnecessarily, wasting radio resources. Some embodiments herein may use proactive configurations to address the issues associated with reactive configurations.

A second issue that some systems face is the uncoordinated configuration of linear packet coding and retransmission mechanisms at different layers. Possible transmit configurations of these packets based on the performance requirements of the application and/or PDU set such as packet error rate, delay budget, throughput, etc. include the following. The configurations may include linear packet coding that is applicable at the application layer and/or PDCP and/or RLC. The configurations may further include radio access transmission configurations (e.g., link adaptation set-up (including logical channel selection, PDCP duplication, RLC re-transmission mode, MAC configuration, etc.)).

Even though linear packet coding schemes provide additional robustness to packet errors and reduction of end-to-end latency, the individual packets and corresponding packet set are still prone to errors in the system, in particular at the air-interface. Moreover, the constraint that all (or a given number of) packets in a set need to be received correctly (e.g., PSER in PDU set), within a latency budget (e.g., PSDB in PDU set) may require additional error handling mechanisms in the system.

Existing linear packet coding schemes at a given layer (e.g., AL) and adaptation mechanisms such as packet duplication at other layers (e.g., PDCP) are not configured in coordination. This results in potentially discarding the overall packet set (e.g., PDU set) once the configured linear packet coding and/or link adaptation do not perform well due to varying system (e.g., wireless) conditions.

Some embodiments herein provide coordinated configuration for selection of linear packet coding parameters and retransmission parameters. Such embodiments may reduce overhead associated with the uncoordinated configuration of linear packet coding and retransmission mechanisms at different layers.

A third issue some wireless communication system face is that XR support in new radio (NR) includes support for handling PDU Set Importance (PSI) and the PDU Set Integrated Handling Indication (PSIHI). When PSIHI is set, RAN drops remaining PDUs belonging to a PDU Set when one of the PDUs belonging to the PDU Set is known to be lost. However, this does not take into consideration the possibility of error recovery by the Application Layer (AL) based on the deployed source coding method. Additionally, using a static source coding configuration at the AL may be wasteful, since it does not track the wirelessly channel variability and the user information (context, motion, etc.). Some embodiments herein provide enhancements to address this issue.

For example, some embodiments may use proactive multi-packet link adaptation. For example, a transmitter may aim to transmit an PDU (or ADU) Set. The PDU set or ADU set may include more than one packets (M packets>1). The PDU set or the ADU set may have a QoS requirement including PDU set (or ADU set) delay budget, PDU set (or ADU set) error rate. The transmitter may encode the PDU set (or the ADU set) with a code rate that is less than one (e.g., Renc<1) in order to provide additional error resilience.

The receiver may conduct some prediction operation based on the reception of a subset of packets (e.g., K packets out of the M packets) packets of the PDU Set (or ADU set). For example, in some embodiments the receiver may use the first K packets (out of M packets of the PDU set or ADU set) to conduct the prediction operation. In some embodiments, the K packets may not be the first packets in the set. The prediction operation may include predicting packet error rate and or delay of the upcoming (N=M−K) packets that are due to be received. In some embodiments, the prediction operation may include deep-learning based temporal domain predictors such as Convolutional Neural Networks (CNNs), or recurrent neural networks (RNN).

Based on the prediction results and PDU set QoS requirement, and configured coding rate (Renc), the receiver may instruct the transmitter regarding how to transmit the remaining N packets (e.g., N=M−K packets). The instruction may include, for example, transmit the remaining packets with different configurations, such as per packet or group of packets RLC mode switching, HARQ mode switching, or discard and/or duplicate of the packets. The transmitter may transmit the remaining packets (N=M−K packets) based on the instructions from the receiver.

Additionally, in some embodiments the receiver may also suggest configurations for upcoming PDU sets or ADU sets. For example, based on the error statistics collected, as well as instructions applied on the previous PDU set, the receiver may provide a suggest code rate update (e.g., Renc) to the transmitter for an upcoming PDU set. The transmitter may use the suggested code rate update for the upcoming PDU set or ADU set.

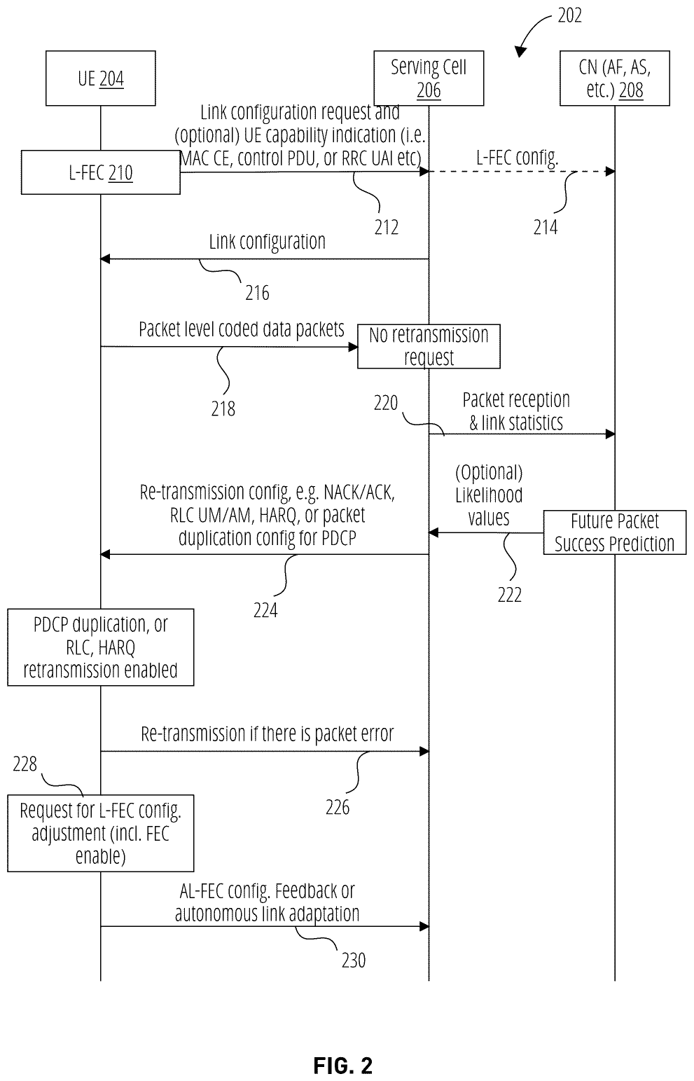

FIG. 2 illustrates an example signal flow diagram 202 of proactive multi-packet link adaptation in the uplink using application layer coding in accordance with some embodiments. Proactive multi-packet link adaptation may be used a multi-packet application (e.g., multi-modal XR traffic with a PDU set, and an application layer use case with an ADU set). The multi-packet stream, PDU set (or ADU set), may be assumed to have KPI constraints. The KPI constraints may include: application delay budget (e.g., PSDB in PDU set); application packet error rate (e.g., PSER in PDU set); etc.

While the illustrated embodiment uses application layer linear packet coding, the linear packet coding may be performed at other layers (e.g., the application layer, and/or PDCP, and/or RLC/MAC, etc.) in some embodiments. The transmitter (e.g., UE 204), in accordance with their KPI constraints, may employ linear packet level coding on the multi-packets, or PDU set or ADU set. The linear packet coding can be employed at the application layer, and/or PDCP, and/or RLC/MAC, etc.

When proactive multi-packet link adaptation is used for application layer, the linear packet coding configuration (e.g., L-FEC configuration) can be determined at the UE 204 and sent to the core network 208 (e.g., Application Server/Function (AS, AF), etc.). Alternatively, in some embodiments the core network 208 can determine the L-FEC configuration and inform the UE 204 of the configuration.

When proactive multi-packet link adaptation is used for PDCP, the linear packet coding configuration (LPC) can be determined at the UE 204 and sent to the network (Radio access network (RAN) (e.g., network node such as gNB), user Plane Function (UPF), an Integrated Access and Backhaul (IAB) node, etc.). Alternatively, in some embodiments the network (e.g., RAN) and/or any involved RAN nodes can determine the LPC configuration and inform the UE 204 of the configuration.

The transmitter (e.g., UE 204) may also employ conventional link configuration procedures such as PDCP duplication, RLC re-transmission mode, etc., in accordance with their KPI constraints.

Despite additional protection mechanisms such as linear packet coding at the higher layers, due to dynamic radio channel conditions, packets in the set (e.g., PDU set and/or ADU set) are prone to failure at the core network and/or RAN. At each received PDU packet (or ADU packet), the receiver may perform the following actions for proactive multi-packet link adaptation in the uplink. The receiver may check whether the packet/PDU is received successfully or not. The receiver may check the time spent for successful reception of a packet/PDU. For example, the receiver may check the time spent by comparing the reception time of the previous packet/PDU in the set with the reception of the said packet. Based on the KPI requirements of the set, i.e., PSDB and PSER in a PDU set, the receiver may identify remaining time and packet error budget for the remaining packets that are anticipated to be received as part of the packet (e.g., PDU) set.

The receiver can employ predictive methods to identify successful versus unsuccessful reception of the anticipated packets (e.g., PDUs or ADUs) within the set. The prediction method can use one or more of the following inputs and provide one or more of the following outputs. The inputs for the predictor of the receiver may include (un)successful reception statistics of the previous packets in the corresponding set; Channel Quality Indicator (CQI)/Channel State Information (CSI) statistics (including L3 and L1 measurements); PDCP discard statistics; HARQ re-transmission statistics, etc. The outputs may include a likelihood (e.g., probability) of X number of packets (e.g., consecutive or nonconsecutive) out of the remaining N number of packets anticipated in the set to be received unsuccessfully; likelihood (e.g., probability) of the total delay value of X number of packets' reception (e.g., consecutive or nonconsecutive) out of the remaining N number of packets in the set to be larger than a threshold. In some embodiments, the prediction operation may include deep-learning based temporal domain predictors such as Convolutional Neural Networks (CNNs), or recurrent neural networks (RNN).

Through L-FEC parameter configuration information and feedback, the transmitter (or receiver) may be informed about the packets (e.g., number of packets) that participate in the L-FEC operation and/or the Data Radio Bearers (DRBs) and QoS flows that participate in the AL-FEC operation. The number of packets that are applied with L-FEC could involve a whole PDU set and/or ADU set.

Based on the prediction outcomes (e.g., predicted likelihood values on packet failure and delay of the anticipated packets in the set) and set KPI requirements (e.g., Delay budget (PSDB), Error rate (PSER), linear packet coding parameters (L-FEC and/or LPC)), the receiver can perform one or more of the following actions. The receiver may discard the existing packets and inform the transmitter not to send (e.g., discard) the remaining packets in the set. For the anticipated packets to be received in the set, the receiver may identify per-packet/PDU or a group of packet/PDU link adaptation and QoS adaptation procedures including the following. The adaption procedures may include packet duplication (e.g., at PDCP), Radio Link Control Automatic Repeat Request Unacknowledged Mode/Acknowledged Mode (RLC ARQ UM/AM) switch, number of HARQ retransmissions per packet, Modulation and Coding Scheme (MCS) selection/adaptation (reduce or increase), etc.

The receiver actions mentioned in these steps can be taken either at the RAN or core network depending on which layer linear packet coding is employed at the following. For linear packet coding employed at PDCP layer or at another layer in AS, the receiver actions may be taken at the RAN. In this case, the core network can configure the RAN with respective (tuning) parameters to be used for the prediction in advance, that is, according to the traffic characteristics of each QoS flow. Some of the tuning parameters could include application layer packet statistics per PDU and/or ADU set among other parameters. Such information can be provided over the interface between RAN and core network.

For linear packet coding employed at application layer, the receiver actions may be taken at the core network. In this case, in some embodiments, the RAN could inform the core network regarding input set for the predictive step of predicting successful/unsuccessful reception of anticipated packets. Further, the core network can provide the output set to the RAN. In some embodiments, RAN and UPF (or centralized unit (CU) and distributed unit (DU)) may exchange new packet headers to convey AL-FEC configuration information, including input and output sets as described in the predictive step, and new code rate per ADU and/or QoS flow, via the user plane (N3 interface), or RAN and AMF/SMF may exchange new control plane messages to convert this information via the N2 interface.

In some embodiments, when the source coding and/or AL-FEC are performed at the application layer, the lower layers at the UE (e.g., PHY, MAC, RLC, PDCP) may adjust their configuration in response to the application encoder change to optimize the overall error performance. For example, a first application encoder setting may result in encoded output that is resistant to up to Y packet errors on the wireless channel, whereas a second encoder setting may result in error resilience for up to Z packet errors. The Application may inform the PHY (and/or MAC, RLC, PDCP) about the encoder setting used for encoding a PDU Set. These measurement and reports can be specific to the particular encoder setting (e.g., source encoder and or L-FEC encoder). The PHY (and/or MAC, RLC, PDCP) may adjust the transmission configuration based on the application encoder setting. For example, PHY (and/or MAC, RLC, PDCP) may continue transmitting the encoded PDUs belonging to a PDU Set until the corresponding number of PDUs are known to be lost (e.g., for application encoder setting 1 more than Y packets are known to be lost). PHY (and/or MAC, RLC, PDCP) may also adjust its HARQ policy (and/or retransmission policies) based on the application encoder setting. The source encoder/AL-FEC setting options can be determined by the network and shared with the UE such that the UE can autonomously select a particular setting option based on such network information.

For example, FIG. 2 illustrates signaling flow between a UE 204 and a core network 208 for proactive multi-packet link adaptation in the uplink using application layer coding in accordance with some embodiments. As shown, the UE 204 may determine the L-FEC configuration 210. The UE 204 may send parameters of the L-FEC configuration 210 via the link configuration request 212. The UE 204 may optionally send a UE capability indication. In some embodiments, the L-FEC configuration 210 and the UE capability indication may be sent via a MAC CE, control PDU, or RRC UAI, etc. The link configuration request 212 may include radio link parameters. For example, the link configuration request 212 may include QoS parameters based on an application delay budget or an application packet error rate.

The serving cell 206 may receive the link configuration request 212 and forward the L-FEC configuration parameters 214 to the core network 208. The serving cell 206 may send the UE 204 a link configuration 216 to the UE 204. The link configuration 216 may include actual parameters and settings that may be applied to the radio link as a result of the link configuration request 212.

The UE 204 may send packet level coded data packets 218 to the serving cell 206. The packet level coded data packets 218 may include data set QoS configuration and KPIs. The serving cell 206 may send packet reception and link statistics 220 to the core network 208. The core network 208 may check whether the packet/PDU is received successfully or not, and checks the time spent for successful reception of a packet/PDU. Based on KPI requirements of the set (e.g., PSDB and PSER in a PDU set) the core network 208 may identify remaining time and packet error budget for the remaining packets that are anticipated to be received as part of the packet (e.g., PDU) set.

The core network 208 may predict successful vs unsuccessful reception of the anticipated packets. The prediction may be based on packet reception and link statistics 220 which may include (Un)Successful reception statistics of the previous packets in the corresponding set; CQI/CSI statistics (including L3 and L1 measurements); PDCP discard statistics; HARQ re-transmission statistics, etc. The core network 208 may output a likelihood of X number of packets out of the remaining N number of packets anticipated in the set to be received unsuccessfully; likelihood of the total delay value of X number of packets' reception out of the remaining N number of packets in the set to be larger than a threshold. In some embodiments, the core network 208 may send the likelihood values 222 to the serving cell 206. In some embodiments, the prediction operation may include deep-learning based temporal domain predictors such as Convolutional Neural Networks (CNNs), or recurrent neural networks (RNN).

Based on the predicted outcomes, the core network 208 and/or serving cell 206 may determine whether to discard the packets already received or send an adaptation request to the UE 204. For example, if the PDU set is likely to fail, the core network 208 may discard the existing packets and the serving cell 206 may inform the UE 204 not to send the remaining packets. If an adaptation may result in successful reception of the PDU set, the core network 208 or serving cell 206 may identify a per-packet/PDU or a group of packet/PDU link adaptation and QoS adaptation procedures including Packet duplication, RLC ARQ UM/AM switch, number of HARQ retransmissions per packet, MCS selection/adaptation (reduce or increase), etc. The serving cell 206 may send the adaptation procedure as a re-transmission configuration 224 to the UE 204. The UE 204 may send a re-transmission 226 if there is a packet in error. The UE 204 may generate a request 228 for L-FEC configuration adjustment (including FEC enable), and send AL-FEC configuration feedback or autonomous link adaptation 230.

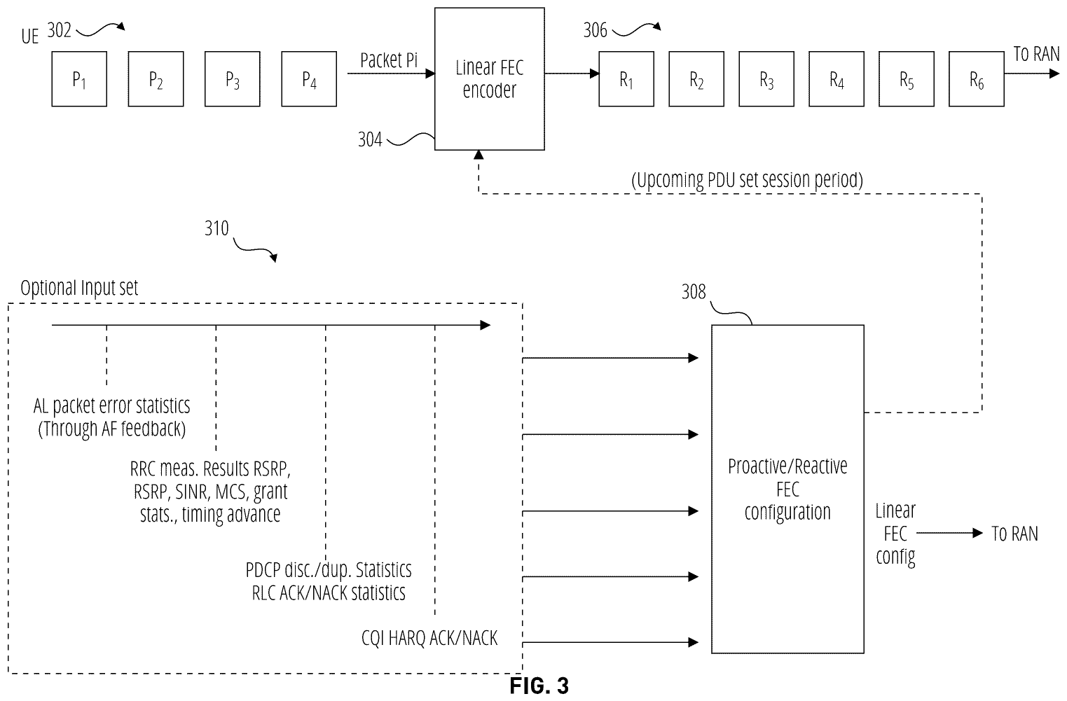

FIG. 3 illustrates specific UE-side procedures for the proactive multi-packet link adaptation in the uplink using application layer coding (e.g., signal flow diagram 202 of FIG. 2) in accordance with some embodiments. At the UE, a PDU set 302 comprising a number of packets (e.g., k PDU packets) may be encoded with linear packet coding (e.g., network coding, fountain codes) with config (k,N). For example, the UE may include a linear FEC encoder 304 that encodes the PDU set 302 with linear packet coding. The linear FEC encoder 304 may output a coded PDU set 306 to be sent to the RAN.

Linear packet coding (e.g., Application layer FEC or PDCP layer packet coding) can reactively (e.g., using instantaneous input set) or proactively (e.g., using statistical input set) configure coded packets considering the scheduled PDU set session period. For example, the UE may include a predictor 308 that generates a proactive/reactive FEC configuration for an upcoming PDU set session period based on a set of inputs 310. The predictor 308 may be an AI/ML mechanism. The inputs 310 may include one or more of AL packet error statistics, RRC measurement results, CQI, HARQ ACK/NACK, PDCP discard/duplicate, or RLC ACK/NACK statistics.

In the uplink, the following options for L-FEC configuration can be considered. In some embodiments, the UE may determine the L-FEC configurations and inform the network. In some embodiments, the network may determine the L-FEC configurations and inform the UE about the FEC configuration parameters.

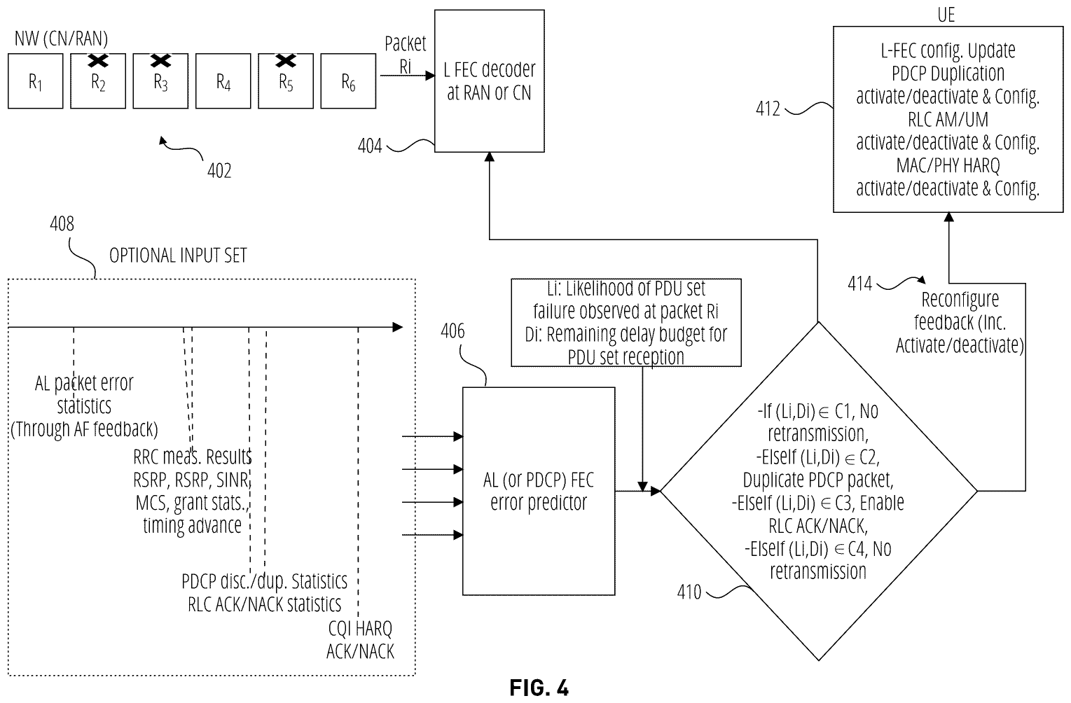

FIG. 4 illustrates specific network-side procedures for the proactive multi-packet link adaptation in the uplink using application layer coding (e.g., signal flow diagram 202 of FIG. 2) in accordance with some embodiments. The network (RAN/core network) may receive the PDU set 402 (k PDU packets) from the UE. In the steps below, in case the linear packet coding/FEC procedures are performed at the application layer, the relevant network node for the part of the receiver operations could be the core network (e.g., AF, AS, etc.). Or, in case the linear FEC procedures are performed at another layer (e.g., PDCP) the relevant network node for the receiver operations could be RAN.

For each received packet (i.e., Ri) the network (RAN/CN) may perform packet error prediction for the overall PDU set. The network (RAN/CN) may determine a likelihood value, Li, for PDU set failure at each Ri. The network (RAN/CN) may also identify the remaining delay budget, Di, for a successful PDU set reception. For example, as shown, some of the packets in the PDU set 402 may be received in error. The network may predict errors or delay of future packets of the PDU set using the error predictor 406. The error predictor 406 may be an AI/ML mechanism that receives inputs 408 and predicts the likelihood value (Li) of PDU set failure observed at packet Ri, and a remaining delay budget for PDU set reception (Di). In some embodiments, the prediction operation may include deep-learning based temporal domain predictors such as Convolutional Neural Networks (CNNs), or recurrent neural networks (RNN).

The inputs 408 to the error predictor 406 may include one or more of PDU Set Size, PDU Set Delay Budget, PDU Packet ID, AL packet error statistics, RRC measurement results, CQI, HARQ ACK/NACK, PDCP discard/duplicate, or RLC ACK/NACK statistics. The network may include an L-FEC decoder 404 at RAN or core network. Note that L-FEC decoder operation may occur at RAN if L-FEC is applied to PDCP and/or RLC. For AL FEC, the decoder operation may be at RAN. The output of the error predictor 406 may be used to configure the L-FEC decoder 404.

The output of the error predictor 406 may be used to determine what type of link adaptation and configuration can be applied. An example of such determination is shown in decision block 410. In the illustrated embodiment, if the likelihood of PDU set failure and the remaining delay budget for PDU set reception belong to set C1, the adaptation may be no retransmission. If the likelihood of PDU set failure and the remaining delay budget for PDU set reception belong to set C2, the adaptation may be to duplicate PDCP packet. If the likelihood of PDU set failure and the remaining delay budget for PDU set reception belong to set C3, the adaptation may be to enable RLC ACK/NACK. If the likelihood of PDU set failure and the remaining delay budget for PDU set reception belong to set C4, the adaptation may be no retransmission.

The network may send reconfiguration feedback 414 to the UE 412 based on the output of decision block 410. The reconfiguration feedback may include activation/deactivation and adaptive configuration details that may be used as a transmission configuration for the future packets of the PDU to be sent by the UE 412. Based on the PDU set failure likelihood value (Li) and remaining delay budget (Di), the network (RAN/CN) may configure a retransmission/redundancy framework reconfiguration feedback, which might include options such as the following. The framework may include configuration of PDCP duplication parameters including (linear) packet level coding for duplicated packets. The framework may include activate/de-activate RLC AM/UM/TM, and configuration of RLC AM mode including (linear) packet coding for packet re-transmission. The framework may include activate/de-activate MAC/PHY HARQ, and configuration of HARQ including FEC selection and configuration. The framework may include other link adaptation configuration (e.g., MCS selection). In some instances, the framework may include the option of discarding all remaining PDUs in the set. In the case of the linear packet coding/FEC procedures are performed at the application layer, then the core network can inform the RAN regarding the Li and Di values, and RAN performs the link adaptation steps mentioned above.

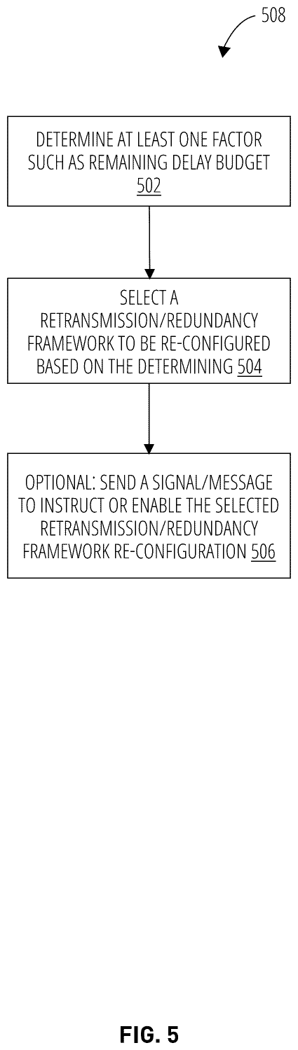

FIG. 5 illustrates a flow chart of an example method 508 for network-side procedures for the proactive multi-packet link adaptation in the uplink in accordance with some embodiments. The RAN/UE can select a particular retransmission/redundancy framework option based on various factors. For example, a network node may determine 502 at least one factor such as remaining delay budget or likelihood of PDU set failure. The network node may select 504 a retransmission/redundancy framework to be re-configured based on the determining.

Selection of the configuration option and corresponding signaling can be based on various factors related to the PDU set and/or packet to be treated at the receiver. In some embodiments, the factors may be relevant to requirements such as remaining delay budget (Di) and/or round-trip-time (RTT). For example, when the remaining delay budget is higher than a threshold T, the RAN/UE may apply retransmission/redundancy framework (and send corresponding signals, if applicable) in the Application layer such as switching to a different AL-FEC scheme. As another example, when the remaining delay budget is equal to or lower than a threshold T, the RAN/UE may apply retransmission/redundancy framework (and send corresponding signals, if applicable) in the AS layer, including re-configuration in PDCP/RLC/MAC operations. If the adaptation is to be performed by the UE, the threshold may be pre-configured by the network node. In some embodiments, the network node may send 506 a signal/message to instruct or enable the selected retransmission/redundancy framework re-configuration.

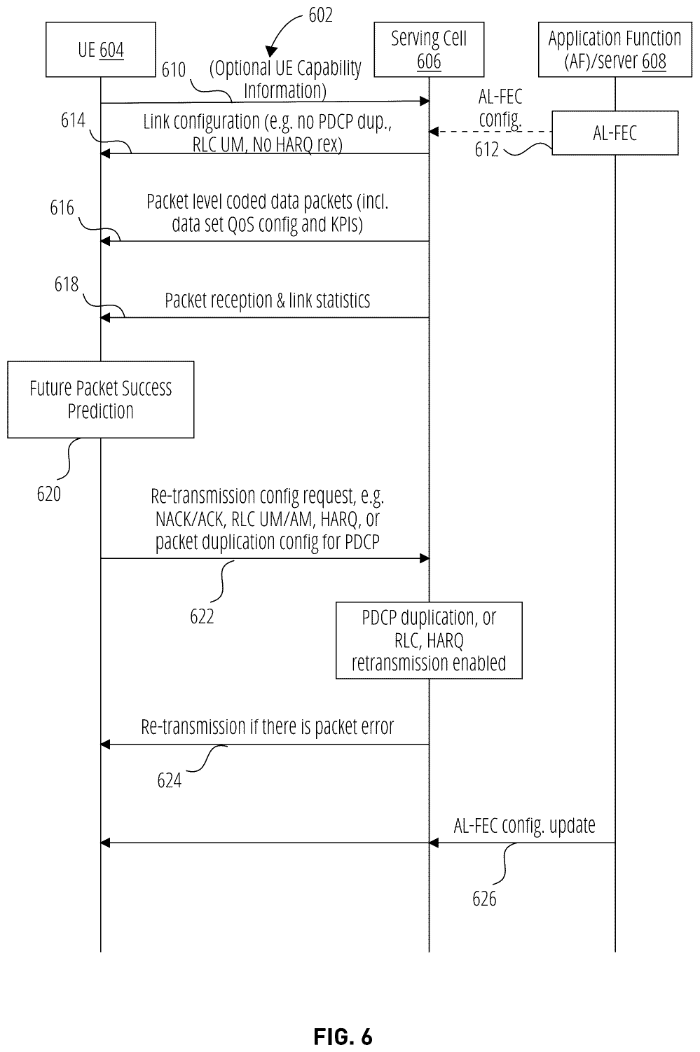

In some embodiments, proactive multi-packet link adaptation may be applied in the downlink. FIG. 6 illustrates an example signal flow diagram 602 of proactive multi-packet link adaptation in the downlink using application layer coding in accordance with some embodiments. Similar to the uplink, a multi-packet application (e.g., multi-modal XR traffic with a PDU set and an application layer use case with an ADU set) may be considered. The multi-packet stream, PDU set (or ADU set), may be assumed to have KPI constraints including application delay budget (e.g., PSDB in PDU set), application packet error rate (e.g., PSER in PDU set), etc.

While the illustrated embodiment uses application layer linear packet coding, the linear packet coding may be performed at other layers (e.g., the application layer, and/or PDCP, and/or RLC/MAC, etc.) in some embodiments. The transmitter (RAN and/or Core Network (e.g., Serving Cell 606 and/or Application Function (AF)/server 608), in accordance with their KPI constraints, may employ linear packet level coding on the multi-packets, or PDU set or ADU set. The linear packet coding can be employed at the application layer, and/or PDCP, and/or RLC/MAC, etc.

When proactive multi-packet link adaptation is used for application layer, the linear packet coding configuration (e.g., L-FEC configuration) can be determined at the network or Application Server (e.g., core network such as Application Function (AF)/server 608) and sent to the UE 604. Alternatively, the UE 604 can determine the L-FEC configuration and inform the network (e.g., AF) of the configuration.

When proactive multi-packet link adaptation is used for PDCP, the linear packet coding configuration (LPC) can be determined at the network (e.g., RAN) and/or any involved RAN nodes and sent to the UE 604.

The transmitter (e.g., network) may also employ conventional link configuration procedures such as PDCP duplication, RLC re-transmission mode, etc., in accordance with their KPI constraints.

Despite additional protection mechanisms such as linear packet coding at the higher layers, due to dynamic radio channel conditions, packets in the set (e.g., PDU set and/or ADU set) are prone to failure at the UE 604. At each received PDU packet (or ADU packet), the receiver (e.g., UE 604) may perform the following actions for proactive multi-packet link adaptation in the downlink.

The receiver may check whether the packet/PDU is received successfully or not. The receiver may check the time spent for successful reception of a packet/PDU. For example, the receiver may check the time spent by comparing the reception time of the previous packet/PDU in the set with the reception of the said packet. Based on the KPI requirements of the set (e.g., PSDB and PSER in a PDU set) the receiver may identify remaining time and packet error budget for the remaining packets that are anticipated to be received as part of the packet (e.g., PDU) set.

The receiver can employ predictive methods to identify successful versus unsuccessful reception of the anticipated packets (e.g., PDUs or ADUs) within the set. The prediction method can use one or more of the following inputs and provide one or more of the following outputs. The inputs for the predictor of the receiver may include (un)successful reception statistics of the previous packets in the corresponding set; Channel Quality Indicator (CQI)/Channel State Information (CSI) statistics (including L3 and L1 measurements); PDCP discard statistics; HARQ re-transmission statistics, etc. The outputs may include a likelihood of X number of packets (e.g., consecutive or nonconsecutive) out of the remaining N number of packets anticipated in the set to be received unsuccessfully; likelihood of the total delay value of X number of packets' reception (e.g., consecutive or nonconsecutive) out of the remaining N number of packets in the set to be larger than a threshold. In some embodiments, the prediction operation may include deep-learning based temporal domain predictors such as Convolutional Neural Networks (CNNs), or recurrent neural networks (RNN).

Through L-FEC parameter configuration information and feedback, the transmitter (or receiver) may be informed about the packets (e.g., number of packets) and/or the DRBs and QoS flows that participate in the AL-FEC operation. The number of packets that are applied with AL-FEC could involve a whole PDU set and/or ADU set.

Based on the prediction outcomes (e.g., predicted likelihood values on packet failure and delay of the anticipated packets in the set) and set KPI requirements (e.g., Delay budget (PSDB), Error rate (PSER), linear packet coding parameters (L-FEC and/or LPC)), the receiver can perform one or more of the following actions. The receiver may discard the existing packets and inform the transmitter not to send (e.g., discard) the remaining packets in the set. For the anticipated packets to be received in the set, the receiver may identify per-packet/PDU or a group of packet/PDU link adaptation and QoS adaptation procedures including the following. The adaption procedures may include packet duplication (e.g., at PDCP), RLC ARQ UM/AM switch, number of HARQ retransmissions per packet, reduced MCS etc.

The receiver actions mentioned in these steps can be feedback to the RAN or CN depending on which layer linear packet coding is employed at the following. For linear packet coding employed at PDCP and/or MAC layer, the receiver actions may be feedback to the RAN. For linear packet coding employed at application layer, the receiver actions may be feedback to the core network. In some embodiments, the UE 604 can send a UE 604 capability information to the network to indicate its AL-FEC and/or LPC and predictive link adaptation capabilities.

For example, FIG. 6 illustrates signaling flow between a UE 604 and an Application Function (AF)/server 608 for proactive multi-packet link adaptation in the downlink using application layer coding in accordance with some embodiments. As shown, the UE 604 may optionally send 610 UE capability information to the Serving Cell 606. The Application Function (AF)/server 608 may generate and send an AL-FEC to the Serving Cell 606.

The Serving Cell 606 may send the UE 604 a link configuration 614 to the UE 604. The link configuration 614 may include parameters and settings that may be applied to the radio link. The Serving Cell 606 may send packet level coded data packets 616 to the UE 604. The packet level coded data packets 616 may include data set QoS configuration and KPIs. The Serving Cell 606 may send packet reception and link statistics 618 to the UE 604.

The UE 604 may check whether the packet/PDU is received successfully or not, and check the time spent for successful reception of a packet/PDU. Based on KPI requirements of the set (e.g., PSDB and PSER in a PDU set) the UE 604 may identify remaining time and packet error budget for the remaining packets that are anticipated to be received as part of the packet (e.g., PDU) set.

The UE 604 may predict 620 successful vs unsuccessful reception of the anticipated packets. The prediction may be based on packet reception and link statistics which may include (Un)Successful reception statistics of the previous packets in the corresponding set; CQI/CSI statistics (including L3 and L1 measurements); PDCP discard statistics; HARQ re-transmission statistics, etc. The UE 604 may output a likelihood of X number of packets out of the remaining N number of packets anticipated in the set to be received unsuccessfully; likelihood of the total delay value of X number of packets' reception out of the remaining N number of packets in the set to be larger than a threshold.

Based on the predicted outcomes, the UE 604 may determine whether to discard the packets already received or send an adaptation request to the Serving Cell 606. For example, if the PDU set is likely to fail, the UE 604 may discard the existing packets and the UE 604 may inform the Serving Cell 606 not to send the remaining packets. If an adaptation may result in successful reception of the PDU set, the UE 604 may identify a per-packet/PDU or a group of packet/PDU link adaptation and QoS adaptation procedures including Packet duplication, RLC ARQ UM/AM switch, number of HARQ retransmissions per packet, MCS selection/adaptation (reduce or increase), etc. The UE Serving Cell 606 may send the adaptation procedure as a re-transmission configuration 622 to the Serving Cell 606. The Serving Cell 606 may send a re-transmission 624 if there is a packet in error. The Application Function (AF)/server 608 send an AL-FEC configuration update 626 to the UE 604 via the Serving Cell 606 based on the adaptation request.

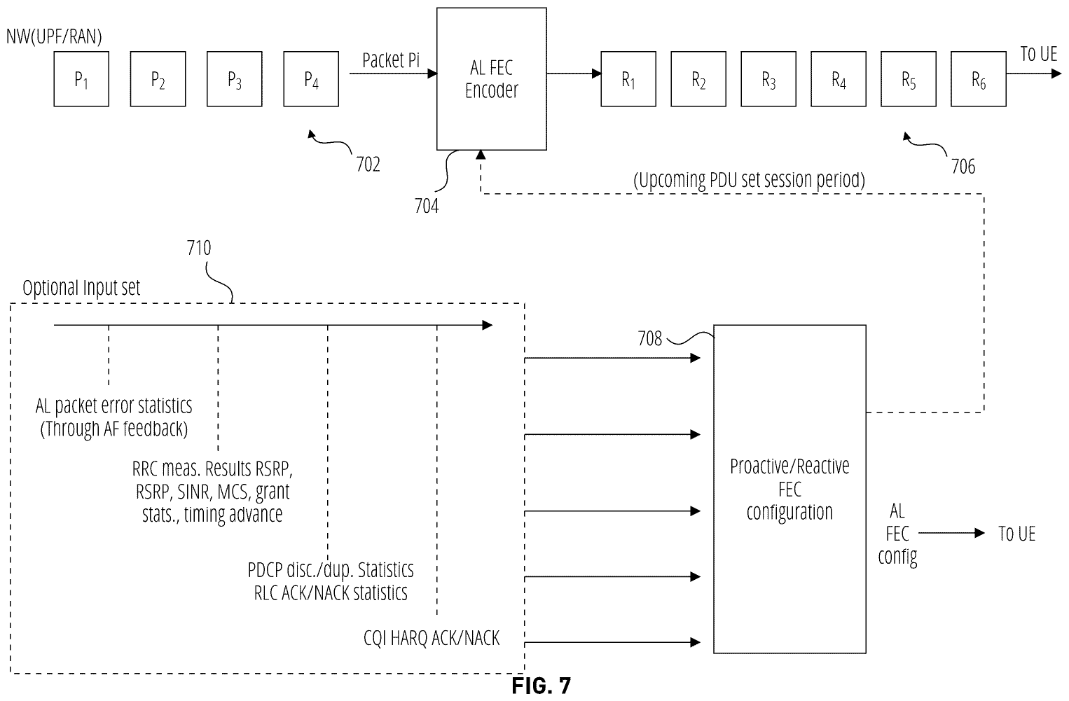

FIG. 7 illustrates specific network-side procedures for the proactive multi-packet link adaptation in the downlink using application layer coding (e.g., signal flow diagram 602 of FIG. 6) in accordance with some embodiments. For example, the UE may include an AL FEC encoder 704 that encodes the PDU set 702 with linear packet coding. The AL FEC encoder 704 may output a coded PDU set 706 to be sent to the UE.

At the network (e.g., CN if FEC (e.g., UPF) is used in AL, or RAN otherwise), a PDU set 702 comprising a number of packets (e.g., k PDU packets) may be encoded with application linear packet coding (e.g., network coding, fountain codes) with config (k,N). Application layer FEC may proactively configure coded packets considering the scheduled PDU set session period. For example, the network may include a predictor 708 that generates an AL FEC configuration for an upcoming PDU set session period based on a set of inputs 710. The predictor 708 may be an AI/ML mechanism. The inputs 710 may include one or more of AL packet error statistics, RRC measurement results, CQI, HARQ ACK/NACK, PDCP discard/duplicate, or RLC ACK/NACK statistics.

In the downlink, the following options for AL-FEC configuration can be considered. In some embodiments, the UE may determine the AL-FEC configurations and inform the network about the preferred AL-FEC configurations. In some embodiments, the network may determine the AL-FEC configurations and inform the UE about the FEC configuration parameters.

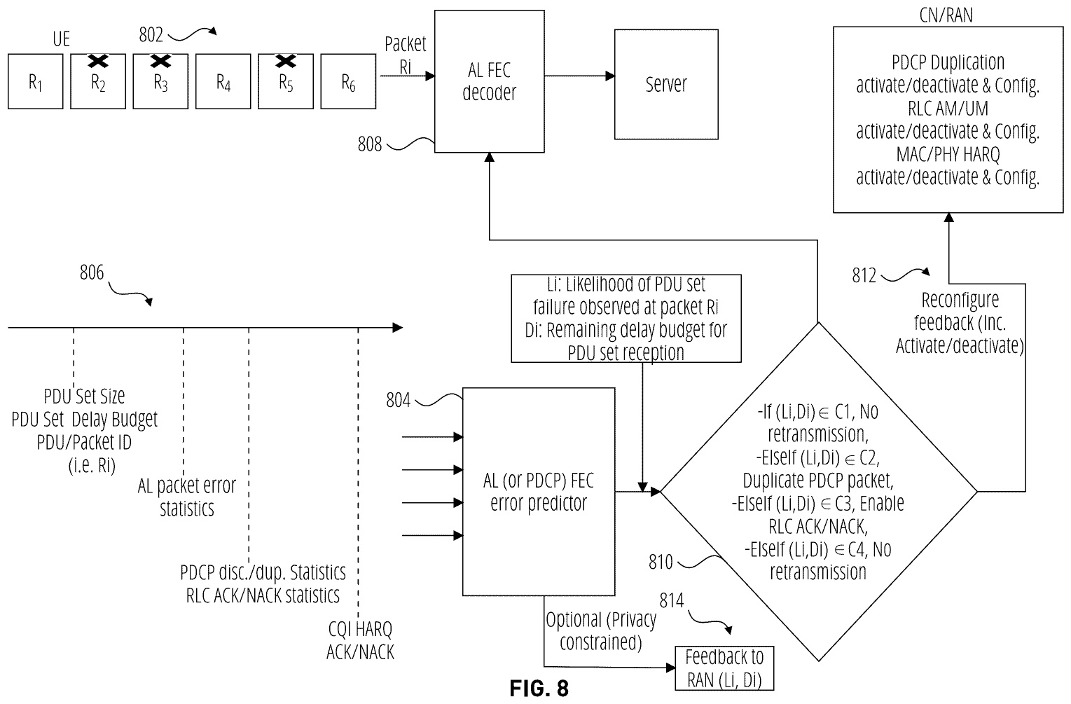

FIG. 8 illustrates specific UE-side procedures for the proactive multi-packet link adaptation in the downlink using application layer coding (e.g., signal flow diagram 602 of FIG. 6) in accordance with some embodiments. The UE may receive the PDU set 802 (k PDU packets) from the network.

For each received packet (i.e., Ri) the UE may perform packet error prediction for the overall PDU set. The UE may determine a likelihood value, Li, for PDU set failure at each Ri. The UE may also identify the remaining delay budget, Di, for a successful PDU set reception. For example, as shown, some of the packets in the PDU set 802 may be received in error. The network may predict errors or delay of future packets of the PDU set using the error predictor 804. The error predictor 804 may be an AI/ML mechanism that receives inputs 806 and predicts the likelihood value (Li) of PDU set failure observed at packet Ri, and a remaining delay budget for PDU set reception (Di). In some embodiments, the prediction operation may include deep-learning based temporal domain predictors such as Convolutional Neural Networks (CNNs), or recurrent neural networks (RNN).

The inputs 806 to the error predictor 804 may include one or more of PDU Set Size, PDU Set Delay Budget, PDU Packet ID, AL packet error statistics, CQI, HARQ ACK/NACK, PDCP discard/duplicate, or RLC ACK/NACK statistics. The network may include an application layer FEC decoder 808 at RAN or core network. The output of the error predictor 804 may be used to configure the application layer FEC decoder 808.

The output of the error predictor 804 may be used to determine what type of link adaptation and configuration can be applied. An example of such determination is shown in decision block 810. In the illustrated embodiment, if the likelihood of PDU set failure and the remaining delay budget for PDU set reception belong to set C1, the adaptation may be no retransmission. If the likelihood of PDU set failure and the remaining delay budget for PDU set reception belong to set C2, the adaptation may be to duplicate PDCP packet. If the likelihood of PDU set failure and the remaining delay budget for PDU set reception belong to set C3, the adaptation may be to enable RLC ACK/NACK. If the likelihood of PDU set failure and the remaining delay budget for PDU set reception belong to set C4, the adaptation may be no retransmission.

The network may send retransmission/redundancy framework reconfiguration feedback 812 to the network based on the output of decision block 810. The reconfiguration feedback may include activation/deactivation and adaptive configuration details that may be used as a transmission configuration for the future packets of the PDU to be sent by the network. Based on the PDU set failure likelihood value (Li) and remaining delay budget (Di), the UE may configure a retransmission/redundancy framework reconfiguration feedback, which might include options such as the following. The framework may include configuration of PDCP duplication parameters including (linear) packet level coding for duplicated packets. The framework may include activate/de-activate RLC AM/UM/TM, and configuration of RLC AM mode including (linear) packet coding for packet re-transmission. The framework may include activate/de-activate MAC/PHY HARQ, and configuration of HARQ including FEC selection and configuration. The framework may include other link adaptation configuration (e.g., MCS selection). In some instances, the framework may include the option of discarding all remaining PDUs in the set.

In some embodiments, the UE simply returns the outcome of the error prediction to the network. This may include sending a report 814 with the PDU set failure likelihood value (Li) and/or associated remaining delay budget.

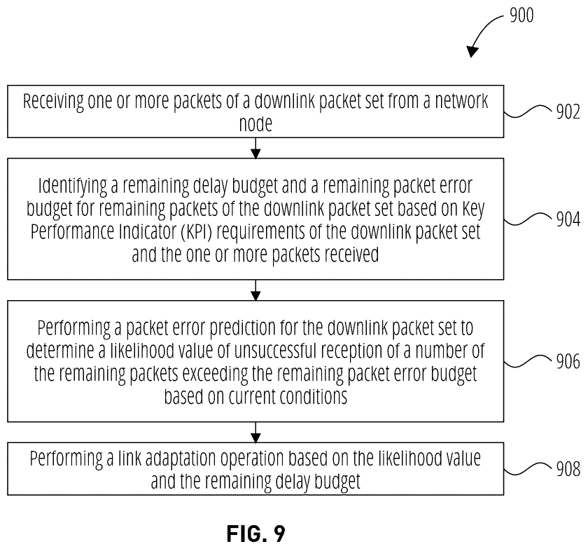

FIG. 9 illustrates a method 900 performed by a UE, according to embodiments herein. The illustrated method 900 includes receiving 902 one or more packets of a downlink packet set from a network node. The method 900 further includes identifying 904 a remaining delay budget and a remaining packet error budget for remaining packets of the downlink packet set based on KPI requirements of the downlink packet set and the one or more packets received. The method 900 further includes performing 906 a packet error prediction for the downlink packet set to determine a likelihood value of unsuccessful reception of a number of the remaining packets exceeding the remaining packet error budget based on current conditions. The method 900 further includes performing 908 a link adaptation operation based on the likelihood value and the remaining delay budget.

In some embodiments of the method 900, the current conditions include one or more of successful reception statistics of the one or more packets received in the packet set, packet set size, packet set delay budget, packet identifier, AL PER, CQI, HARQ acknowledgment or negative-acknowledgment, PDCP, PDCP discard statistics, or RLC acknowledgment or negative-acknowledgment statistics.

In some embodiments of the method 900, performing the link adaptation operation comprises generating retransmission or redundancy framework reconfiguration feedback, and sending the retransmission or redundancy framework reconfiguration feedback to the network node.

In some embodiments of the method 900, the retransmission or redundancy framework reconfiguration feedback comprises a configuration of PDCP duplication parameters including linear packet level coding for duplicated packets. In some such embodiments, the retransmission or redundancy framework reconfiguration feedback comprises activation or de-activation RLC Acknowledged Mode, Unacknowledged Mode, or Transparent Mode, and configuration of RLC Acknowledged Mode including linear packet coding for packet re-transmission. In some other such embodiments, the retransmission or redundancy framework reconfiguration feedback comprises activation or de-activation MAC or PHY HARQ, and a configuration of the MAC or PHY HARQ including FEC selection and configuration.

In some embodiments of the method 900, performing the link adaptation operation comprises discarding all remaining packets in the packet set when the KPI requirements will not be met.

In some embodiments, the method 900 further comprises sending an outcome of the packet error prediction to the network node.

In some embodiments, the method 900 further comprises sending UE capability information to the network node to indicate application layer forward error correction capabilities or linear predictive coding capabilities, and predictive link adaptation capabilities.

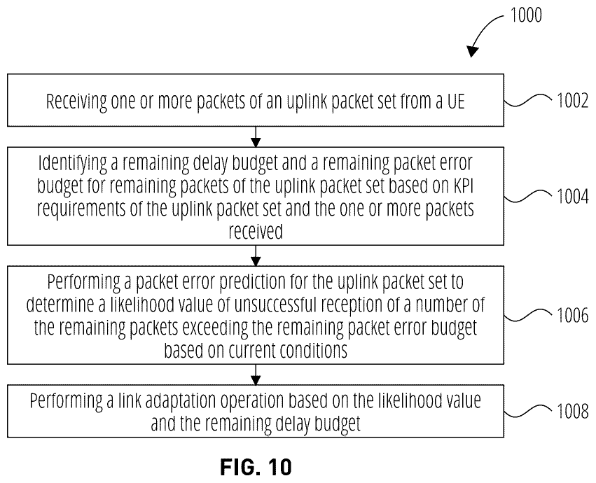

FIG. 10 illustrates a method 1000 performed by a network node, according to embodiments herein. The illustrated method 1000 includes receiving 1002 one or more packets of an uplink packet set from a UE. The method 1000 further includes identifying 1004 a remaining delay budget and a remaining packet error budget for remaining packets of the uplink packet set based on KPI requirements of the uplink packet set and the one or more packets received. The method 1000 further includes performing 1006 a packet error prediction for the uplink packet set to determine a likelihood value of unsuccessful reception of a number of the remaining packets exceeding the remaining packet error budget based on current conditions. The method 1000 further includes performing 1008 a link adaptation operation based on the likelihood value and the remaining delay budget.

In some embodiments of the method 1000, performing the link adaptation operation comprises generating retransmission or redundancy framework reconfiguration feedback, and sending the retransmission or redundancy framework reconfiguration feedback to the UE. In some such embodiments, the retransmission or redundancy framework reconfiguration feedback comprises a configuration of PDCP duplication parameters including linear packet level coding for duplicated packets. In some other such embodiments, the retransmission or redundancy framework reconfiguration feedback comprises activation or de-activation RLC Acknowledged Mode, Unacknowledged Mode, or Transparent Mode, and configuration of RLC Acknowledged Mode, including linear packet coding for packet re-transmission. In yet some other such embodiments, the retransmission or redundancy framework reconfiguration feedback comprises activation or de-activation MAC or PHY HARQ, and a configuration of the MAC or PHY HARQ, including FEC selection and configuration.

In some embodiments of the method 1000, performing the link adaptation operation comprises discarding all remaining packets in the packet set when the KPI requirements will not be met.

In some embodiments, the method 1000 further comprises determining source encoder setting options and sending the source encoder setting options to the UE, such that the UE can autonomously select a particular setting option based on information from the network node.

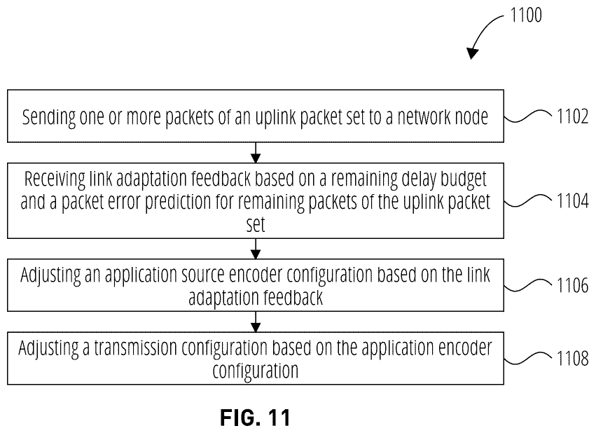

FIG. 11 illustrates a method 1100 performed by a UE, according to embodiments herein. The illustrated method 1100 includes sending 1102 one or more packets of an uplink packet set to a network node. The method 1100 further includes receiving 1104 link adaptation feedback based on a remaining delay budget and a packet error prediction for remaining packets of the uplink packet set. The method 1100 further includes adjusting 1106 an application source encoder configuration based on the link adaptation feedback. The method 1100 further includes adjusting 1108 a transmission configuration based on the application encoder configuration.

In some embodiments of the method 1100, adjusting the transmission configuration comprises continuing to transmit encoded packets belonging to the packet set until a threshold number of packets are lost.

In some embodiments, the method 1100 further comprises adjusting a HARQ policy or retransmission policy based on the application encoder configuration.

In some embodiments, the method 1100 further comprises receiving, from the network node, source encoder setting options and autonomously selecting a particular setting option based on information from the network node.

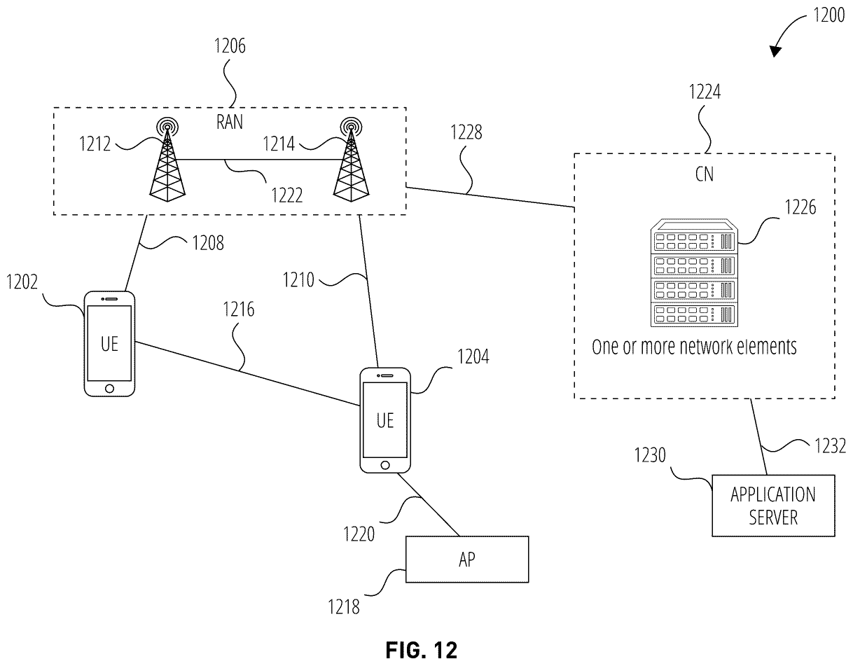

FIG. 12 illustrates an example architecture of a wireless communication system 1200, according to embodiments disclosed herein. The following description is provided for an example wireless communication system 1200 that operates in conjunction with the LTE system standards and/or 5G or NR system standards as provided by 3GPP technical specifications.

As shown by FIG. 12, the wireless communication system 1200 includes UE 1202 and UE 1204 (although any number of UEs may be used). In this example, the UE 1202 and the UE 1204 are illustrated as smartphones (e.g., handheld touchscreen mobile computing devices connectable to one or more cellular networks), but may also comprise any mobile or non-mobile computing device configured for wireless communication.

The UE 1202 and UE 1204 may be configured to communicatively couple with a RAN 1206. In embodiments, the RAN 1206 may be NG-RAN, E-UTRAN, etc. The UE 1202 and UE 1204 utilize connections (or channels) (shown as connection 1208 and connection 1210, respectively) with the RAN 1206, each of which comprises a physical communications interface. The RAN 1206 can include one or more base stations (such as base station 1212 and base station 1214) that enable the connection 1208 and connection 1210.

In this example, the connection 1208 and connection 1210 are air interfaces to enable such communicative coupling, and may be consistent with RAT(s) used by the RAN 1206, such as, for example, an LTE and/or NR.

In some embodiments, the UE 1202 and UE 1204 may also directly exchange communication data via a sidelink interface 1216. The UE 1204 is shown to be configured to access an access point (shown as AP 1218) via connection 1220. By way of example, the connection 1220 can comprise a local wireless connection, such as a connection consistent with any IEEE 802.11 protocol, wherein the AP 1218 may comprise a Wi-Fi® router. In this example, the AP 1218 may be connected to another network (for example, the Internet) without going through a CN 1224.

In embodiments, the UE 1202 and UE 1204 can be configured to communicate using orthogonal frequency division multiplexing (OFDM) communication signals with each other or with the base station 1212 and/or the base station 1214 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 1212 or base station 1214 may be implemented as one or more software entities running on server computers as part of a virtual network. In addition, or in other embodiments, the base station 1212 or base station 1214 may be configured to communicate with one another via interface 1222. In embodiments where the wireless communication system 1200 is an LTE system (e.g., when the CN 1224 is an EPC), the interface 1222 may be an X2 interface. The X2 interface may be defined between two or more base stations (e.g., two or more eNBs and the like) that connect to an EPC, and/or between two eNBs connecting to the EPC. In embodiments where the wireless communication system 1200 is an NR system (e.g., when CN 1224 is a 5GC), the interface 1222 may be an Xn interface. The Xn interface is defined between two or more base stations (e.g., two or more gNBs and the like) that connect to 5GC, between a base station 1212 (e.g., a gNB) connecting to 5GC and an eNB, and/or between two eNBs connecting to 5GC (e.g., CN 1224).

The RAN 1206 is shown to be communicatively coupled to the CN 1224. The CN 1224 may comprise one or more network elements 1226, which are configured to offer various data and telecommunications services to customers/subscribers (e.g., users of UE 1202 and UE 1204) who are connected to the CN 1224 via the RAN 1206. The components of the CN 1224 may be implemented in one physical device or separate physical devices including components to read and execute instructions from a machine-readable or computer-readable medium (e.g., a non-transitory machine-readable storage medium).

In embodiments, the CN 1224 may be an EPC, and the RAN 1206 may be connected with the CN 1224 via an S1 interface 1228. In embodiments, the S1 interface 1228 may be split into two parts, an S1 user plane (S1-U) interface, which carries traffic data between the base station 1212 or base station 1214 and a serving gateway (S-GW), and the S1-MME interface, which is a signaling interface between the base station 1212 or base station 1214 and mobility management entities (MMEs).

In embodiments, the CN 1224 may be a 5GC, and the RAN 1206 may be connected with the CN 1224 via an NG interface 1228. In embodiments, the NG interface 1228 may be split into two parts, an NG user plane (NG-U) interface, which carries traffic data between the base station 1212 or base station 1214 and a user plane function (UPF), and the S1 control plane (NG-C) interface, which is a signaling interface between the base station 1212 or base station 1214 and access and mobility management functions (AMFs).

Generally, an application server 1230 may be an element offering applications that use internet protocol (IP) bearer resources with the CN 1224 (e.g., packet switched data services). The application server 1230 can also be configured to support one or more communication services (e.g., VoIP sessions, group communication sessions, etc.) for the UE 1202 and UE 1204 via the CN 1224. The application server 1230 may communicate with the CN 1224 through an IP communications interface 1232.

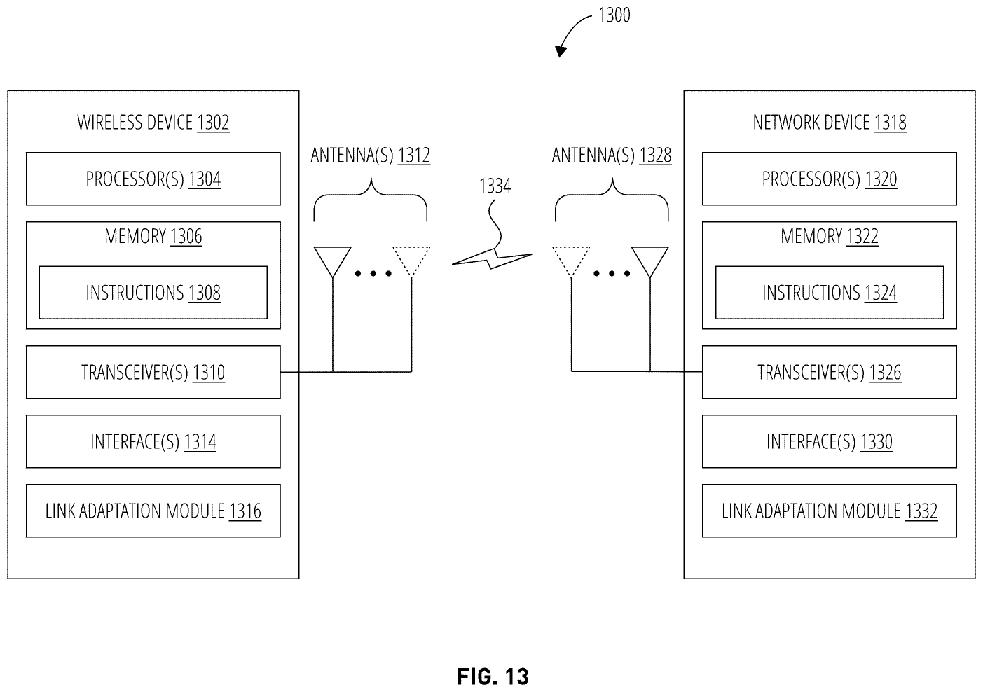

FIG. 13 illustrates a system 1300 for performing signaling 1334 between a wireless device 1302 and a network device 1318, according to embodiments disclosed herein. The system 1300 may be a portion of a wireless communications system as herein described. The wireless device 1302 may be, for example, a UE of a wireless communication system. The network device 1318 may be, for example, a base station (e.g., an eNB or a gNB) of a wireless communication system.

The wireless device 1302 may include one or more processor(s) 1304. The processor(s) 1304 may execute instructions such that various operations of the wireless device 1302 are performed, as described herein. The processor(s) 1304 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1302 may include a memory 1306. The memory 1306 may be a non-transitory computer-readable storage medium that stores instructions 1308 (which may include, for example, the instructions being executed by the processor(s) 1304). The instructions 1308 may also be referred to as program code or a computer program. The memory 1306 may also store data used by, and results computed by, the processor(s) 1304.

The wireless device 1302 may include one or more transceiver(s) 1310 that may include radio frequency (RF) transmitter circuitry and/or receiver circuitry that use the antenna(s) 1312 of the wireless device 1302 to facilitate signaling (e.g., the signaling 1334) to and/or from the wireless device 1302 with other devices (e.g., the network device 1318) according to corresponding RATs.

The wireless device 1302 may include one or more antenna(s) 1312 (e.g., one, two, four, or more). For embodiments with multiple antenna(s) 1312, the wireless device 1302 may leverage the spatial diversity of such multiple antenna(s) 1312 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 1302 may be accomplished according to precoding (or digital beamforming) that is applied at the wireless device 1302 that multiplexes the data streams across the antenna(s) 1312 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 1302 may implement analog beamforming techniques, whereby phases of the signals sent by the antenna(s) 1312 are relatively adjusted such that the (joint) transmission of the antenna(s) 1312 can be directed (this is sometimes referred to as beam steering).

The wireless device 1302 may include one or more interface(s) 1314. The interface(s) 1314 may be used to provide input to or output from the wireless device 1302. For example, a wireless device 1302 that is a UE may include interface(s) 1314 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 1310/antenna(s) 1312 already described) that allow for communication between the UE and other devices and may operate according to known protocols (e.g., Wi-Fi®, Bluetooth®, and the like).

The wireless device 1302 may include a link adaptation module 1316. The link adaptation module 1316 may be implemented via hardware, software, or combinations thereof. For example, the link adaptation module 1316 may be implemented as a processor, circuit, and/or instructions 1308 stored in the memory 1306 and executed by the processor(s) 1304. In some examples, the link adaptation module 1316 may be integrated within the processor(s) 1304 and/or the transceiver(s) 1310. For example, the link adaptation module 1316 may be implemented by a combination of software components (e.g., executed by a DSP or a general processor) and hardware components (e.g., logic gates and circuitry) within the processor(s) 1304 or the transceiver(s) 1310.

The link adaptation module 1316 may be used for various aspects of the present disclosure, for example, aspects of FIGS. 1-12.

The network device 1318 may include one or more processor(s) 1320. The processor(s) 1320 may execute instructions such that various operations of the network device 1318 are performed, as described herein. The processor(s) 1320 may include one or more baseband processors implemented using, for example, a CPU, a DSP, an ASIC, a controller, an FPGA device, another hardware device, a firmware device, or any combination thereof configured to perform the operations described herein.

The network device 1318 may include a memory 1322. The memory 1322 may be a non-transitory computer-readable storage medium that stores instructions 1324 (which may include, for example, the instructions being executed by the processor(s) 1320). The instructions 1324 may also be referred to as program code or a computer program. The memory 1322 may also store data used by, and results computed by, the processor(s) 1320.

The network device 1318 may include one or more transceiver(s) 1326 that may include RF transmitter circuitry and/or receiver circuitry that use the antenna(s) 1328 of the network device 1318 to facilitate signaling (e.g., the signaling 1334) to and/or from the network device 1318 with other devices (e.g., the wireless device 1302) according to corresponding RATs.

The network device 1318 may include one or more antenna(s) 1328 (e.g., one, two, four, or more). In embodiments having multiple antenna(s) 1328, the network device 1318 may perform MIMO, digital beamforming, analog beamforming, beam steering, etc., as has been described.

The network device 1318 may include one or more interface(s) 1330. The interface(s) 1330 may be used to provide input to or output from the network device 1318. For example, a network device 1318 that is a base station may include interface(s) 1330 made up of transmitters, receivers, and other circuitry (e.g., other than the transceiver(s) 1326/antenna(s) 1328 already described) that enables the base station to communicate with other equipment in a core network, and/or that enables the base station to communicate with external networks, computers, databases, and the like for purposes of operations, administration, and maintenance of the base station or other equipment operably connected thereto.

The network device 1318 may include a link adaptation module 1332. The link adaptation module 1332 may be implemented via hardware, software, or combinations thereof. For example, the link adaptation module 1332 may be implemented as a processor, circuit, and/or instructions 1324 stored in the memory 1322 and executed by the processor(s) 1320. In some examples, the link adaptation module 1332 may be integrated within the processor(s) 1320 and/or the transceiver(s) 1326. For example, the link adaptation module 1332 may be implemented by a combination of software components (e.g., executed by a DSP or a general processor) and hardware components (e.g., logic gates and circuitry) within the processor(s) 1320 or the transceiver(s) 1326.

The link adaptation module 1332 may be used for various aspects of the present disclosure, for example, aspects of FIGS. 1-12.

Embodiments contemplated herein include an apparatus comprising means to perform one or more elements of either of the method 900 and method 1100. This apparatus may be, for example, an apparatus of a UE (such as a wireless device 1302 that is a UE, as described herein).

Embodiments contemplated herein include one or more non-transitory computer-readable media comprising instructions to cause an electronic device, upon execution of the instructions by one or more processors of the electronic device, to perform one or more elements of either of the method 900 and method 1100. This non-transitory computer-readable media may be, for example, a memory of a UE (such as a memory 1306 of a wireless device 1302 that is a UE, as described herein).

Embodiments contemplated herein include an apparatus comprising logic, modules, or circuitry to perform one or more elements of either of the method 900 and method 1100. This apparatus may be, for example, an apparatus of a UE (such as a wireless device 1302 that is a UE, as described herein).

Embodiments contemplated herein include an apparatus comprising: one or more processors and one or more computer-readable media comprising instructions that, when executed by the one or more processors, cause the one or more processors to perform one or more elements of either of the method 900 and method 1100. This apparatus may be, for example, an apparatus of a UE (such as a wireless device 1302 that is a UE, as described herein).

Embodiments contemplated herein include a signal as described in or related to one or more elements of either of the method 900 and method 1100.

Embodiments contemplated herein include a computer program or computer program product comprising instructions, wherein execution of the program by a processor is to cause the processor to carry out one or more elements of either of the method 900 and method 1100. The processor may be a processor of a UE (such as a processor(s) 1304 of a wireless device 1302 that is a UE, as described herein). These instructions may be, for example, located in the processor and/or on a memory of the UE (such as a memory 1306 of a wireless device 1302 that is a UE, as described herein).

Embodiments contemplated herein include an apparatus comprising means to perform one or more elements of the method 1000. This apparatus may be, for example, an apparatus of a base station (such as a network device 1318 that is a base station, as described herein).

Embodiments contemplated herein include one or more non-transitory computer-readable media comprising instructions to cause an electronic device, upon execution of the instructions by one or more processors of the electronic device, to perform one or more elements of the method 1000. This non-transitory computer-readable media may be, for example, a memory of a base station (such as a memory 1322 of a network device 1318 that is a base station, as described herein).

Embodiments contemplated herein include an apparatus comprising logic, modules, or circuitry to perform one or more elements of the method 1000. This apparatus may be, for example, an apparatus of a base station (such as a network device 1318 that is a base station, as described herein).

Embodiments contemplated herein include an apparatus comprising: one or more processors and one or more computer-readable media comprising instructions that, when executed by the one or more processors, cause the one or more processors to perform one or more elements of the method 1000. This apparatus may be, for example, an apparatus of a base station (such as a network device 1318 that is a base station, as described herein).

Embodiments contemplated herein include a signal as described in or related to one or more elements of the method 1000.

Embodiments contemplated herein include a computer program or computer program product comprising instructions, wherein execution of the program by a processing element is to cause the processing element to carry out one or more elements of the method 1000. The processor may be a processor of a base station (such as a processor(s) 1320 of a network device 1318 that is a base station, as described herein). These instructions may be, for example, located in the processor and/or on a memory of the base station (such as a memory 1322 of a network device 1318 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method performed by a UE, the method comprising:
receiving one or more packets of a downlink packet set from a network node;
identifying a remaining delay budget and a remaining packet error budget for remaining packets of the downlink packet set based on Key Performance Indicator (KPI) requirements of the downlink packet set and the one or more packets received;
performing a packet error prediction for the downlink packet set to determine a likelihood value of unsuccessful reception of a number of the remaining packets exceeding the remaining packet error budget based on current conditions; and
performing a link adaptation operation based on the likelihood value and the remaining delay budget.

2. The method of claim 1, wherein the current conditions include one or more of successful reception statistics of the one or more packets received in the packet set, packet set size, packet set delay budget, packet identifier, Application Layer (AL) packet error rate (PER), Channel Quality Indicator (CQI), Hybrid Automatic Repeat Request (HARQ) acknowledgment or negative-acknowledgment, Packet Data Convergence Protocol (PDCP), PDCP discard statistics, or Radio Link Control (RLC) acknowledgment or negative-acknowledgment statistics.

3. The method of claim 1, wherein performing the link adaptation operation comprises generating retransmission or redundancy framework reconfiguration feedback, and sending the retransmission or redundancy framework reconfiguration feedback to the network node.

4. The method of claim 3, wherein the retransmission or redundancy framework reconfiguration feedback comprises a configuration of PDCP duplication parameters including linear packet level coding for duplicated packets.

5. The method of claim 3, wherein the retransmission or redundancy framework reconfiguration feedback comprises activation or de-activation Radio Link Control (RLC) Acknowledged Mode, Unacknowledged Mode, or Transparent Mode, and configuration of RLC Acknowledged Mode including linear packet coding for packet re-transmission.

6. The method of claim 3, wherein the retransmission or redundancy framework reconfiguration feedback comprises activation or de-activation Medium Access Control (MAC) or Physical Layer (PHY) Hybrid Automatic Repeat Request (HARQ), and configuration of the MAC or PHY HARQ including Forward Error Correction (FEC) selection and configuration.

7. The method of claim 1, wherein performing the link adaptation operation comprises discarding all remaining packets in the packet set when the KPI requirements will not be met.

8. The method of claim 1, further comprising sending an outcome of the packet error prediction to the network node.

9. The method of claim 1, further comprising sending UE capability information to the network node to indicate application layer forward error correction capabilities or linear predictive coding capabilities, and predictive link adaptation capabilities.

10. A method performed by a network node, the method comprising:
receiving one or more packets of an uplink packet set from a user equipment (UE);
identifying a remaining delay budget and a remaining packet error budget for remaining packets of the uplink packet set based on Key Performance Indicator (KPI) requirements of the uplink packet set and the one or more packets received;
performing a packet error prediction for the uplink packet set to determine a likelihood value of unsuccessful reception of a number of the remaining packets exceeding the remaining packet error budget based on current conditions; and
performing a link adaptation operation based on the likelihood value and the remaining delay budget.

11. The method of claim 10, wherein performing the link adaptation operation comprises generating retransmission or redundancy framework reconfiguration feedback, and sending the retransmission or redundancy framework reconfiguration feedback to the UE.

12. The method of claim 11, wherein the retransmission or redundancy framework reconfiguration feedback comprises a configuration of Packet Data Convergence Protocol (PDCP) duplication parameters including linear packet level coding for duplicated packets.

13. The method of claim 11, wherein the retransmission or redundancy framework reconfiguration feedback comprises activation or de-activation Radio Link Control (RLC) Acknowledged Mode, Unacknowledged Mode, or Transparent Mode, and configuration of RLC Acknowledged Mode including linear packet coding for packet re-transmission.

14. The method of claim 11, wherein the retransmission or redundancy framework reconfiguration feedback comprises activation or de-activation Medium Access Control (MAC) or Physical Layer (PHY) Hybrid Automatic Repeat Request (HARQ), and a configuration of the MAC or PHY HARQ including Forward Error Correction (FEC) selection and configuration.

15. The method of claim 10, wherein performing the link adaptation operation comprises discarding all remaining packets in the packet set when the KPI requirements will not be met.

16. The method of claim 10, further comprising determining source encoder setting options and sending the source encoder setting options to the UE such that the UE can autonomously select a particular setting option based on information from the network node.

17. A method performed by a user equipment (UE) the method comprising:
sending one or more packets of an uplink packet set to a network node;
receiving link adaptation feedback based on a remaining delay budget and a packet error prediction for remaining packets of the uplink packet set;
adjusting an application source encoder configuration based on the link adaptation feedback; and
adjusting a transmission configuration based on the application source encoder configuration.

18. The method of claim 17, wherein adjusting the transmission configuration comprises continuing to transmit encoded packets belonging to the packet set until a threshold number of packets are lost.

19. The method of claim 17, further comprising adjusting a Hybrid Automatic Repeat Request (HARQ) policy or retransmission policy based on the application source encoder configuration.

20. The method of claim 17, further comprising receiving, from the network node, source encoder setting options and autonomously selecting a particular setting option based on information from the network node.
